(19) United States
(12) Patent Application Publication
(10) Pub. No.: US 2025/0327650 A1
(43) Pub. Date: Oct. 23, 2025

(54) DIGITAL TAPE MEASURE AND ANGLE FINDER

(71) Applicant: Michael Donnell, Sandy, UT (US)

(72) Inventor: Michael Donnell, Sandy, UT (US)

(21) Appl. No.: 19/183,033

(22) Filed: Apr. 18, 2025

Related U.S. Application Data
(60) Provisional application No. 63/635,874, filed on Apr. 18, 2024.

(51) Int. Cl. G01B 3/1069; G01B 3/1003; G01B 3/1094; G01B 3/56

(52) U.S. Cl. CPC G01B 3/1069; G01B 3/1003; G01B 3/1094; G01B 3/56

(57) ABSTRACT

This disclosure extends to systems, apparatus, and methods related to digital tape measure systems including a digital angle-finder, which are able to record and store or transmit to an external device both a length measurement and an angle measurement. These measurements may be able to be recorded individually or together in one “capture” motion, such as pushing a “record” button. Such a system allows a user to easily record a length of material and an angle indicating where and how the material needs to be cut.

In some illustrative embodiments, systems in accordance with the present disclosure utilized units of measurement that are displayed by the digital tape measure in a form that can easily be recorded by hand by simple visual reading of the numbers, while simultaneously allowing measurements from the system to be displayed or recorded by the onboard computer.

### CROSS-REFERENCE TO RELATED APPLICATIONS

This application claims the benefit of U.S. Provisional Application No. 63/635,874, filed Apr. 18, 2024, the disclosure of which is incorporated herein by reference in its entirety.

### TECHNICAL FIELD

This disclosure relates to a digital tape measure and a digital angle-finder that can be used to record multiple dimensions simultaneously, for use with woodworking, metalworking, or other type of machinery and related methods, systems, and devices.

### BACKGROUND

Professional and hobby woodworkers, metal workers, flooring installers, and the like use a tape measure and a protractor or angle-finder tool to get an accurately measured cut. These tools can be analog or digital. Digital tape measures typically range in cost from $30 to $300, depending on features and accuracy. Digital angle-finders range in cost from $10-$30, depending on features and accuracy. These two types of tools are frequently used together to determine how long the material needs to be and at what angle the saw needs to be set at in order to get a good cut and for the material to have a good fit into the project.

Accurate measurements are critical, particularly with precision projects such as woodworking and metalworking. The introduction of human decisions makes obtaining an accurate cut prone to error. These errors can be compounded when measurements are at atypical lengths (e.g., increments of fractions of an inch), or when they include non-right-angle cuts.

### SUMMARY

The disclosure describes a digital tape measure system that includes a digital angle-finder that is able to record and store or transmit to an external device both a length measurement and an angle measurement. These measurements may be able to be recorded individually or together in one “capture” motion, such as pushing a “record” button. Such a system allows a user to easily record a length of material and an angle to be used to indicate where and how the material needs to be cut.

In some illustrative embodiments, systems in accordance with the present disclosure utilized units of measurement that are displayed by the digital tape measure in a form that can easily be recorded by hand by simple visual reading of the numbers, while simultaneously allowing measurements from the system to be displayed or recorded by the onboard computer and recalled later, and/or to be sent wirelessly or via a wired cable to an external device, such as a cell phone or a computer with a computer-aided design (CAD) program.

Illustrative systems in accordance with the present invention may have a single body with features that act as both a digital tape measure and a digital angle finder. These systems allow for measuring recording and/or transmitting length and/or angle for a cut that may be performed with a cutting system. In some embodiments, a button on the body may be actuated to record an angle, and a separate button actuated to record length. Then either a user may push a “transmit” button to send it to a cutting system, data collector/recorder or a cell phone. In others, a single button may record both angle and measurement data.

In some embodiments, the digital angle-finder can be incorporated as an endpoint indicating where to begin a measurement. Instead of only the front end (where the blade comes out) and the back end (opposite of where the blade comes out), the digital angle-finder arm can be used as an end point indicating where to begin a measure, including angled measurements that use an onboard processor to perform calculations for angles and distance.

Systems in accordance with the present disclosure may feature a linear encoder used to read special tick marks on the tape measure blade that are used to encode position. By using uniquely designed tick marks printed on the blade, the same tick marks can be used for visual reading by a person and reading with a linear encoder/optical reader. In some embodiments, this may use a specific pattern printed on the blade with a pointed tick mark to ensure that the proper location of the tape is readable by both a machine and a person. In other embodiments, where the digital tape measure reader may use a sensor that shines a light on the tape measure and measures how reflective the surface is. For example, the same color paints but in a gloss finish and a matte finish for background and tick marks on a banded portion of the blade may be used. Alternatively, an upper clear reflective layer may be removed by etching to produce tick marks of the same visible color. Such tick marks could be visible to the electronics while remaining nearly invisible to a person. This would allow the same area on the tape to have indicia, such as numbers or logos, that are visible to people while not interfering with the sensors or other electronics.

The above summary is not intended to describe each illustrated embodiment or every implementation of the subject matter herein. The figures and the detailed descriptions that follow more particularly exemplify various embodiments. The features and advantages of the disclosure will be set forth in the description, which follows, and in part will be apparent from the description, or may be learned by the practice of the disclosure without undue experimentation. The features and advantages of the disclosure may be realized and obtained by means of the instruments and combinations particularly pointed out in the appended claims. Any discussion of documents, acts, materials, devices, articles, or the like, which has been included in the specification is not to be taken as an admission that any or all these matters form part of the prior art base or were common general knowledge in the field relevant to the disclosure as it existed before the priority date of each claim of this disclosure.

### BRIEF DESCRIPTION OF THE DRAWINGS

Non-limiting and non-exhaustive implementations of the disclosure are described with reference to the following figures, wherein like reference numerals refer to like parts throughout the various views unless otherwise specified. Advantages of the disclosure will become better understood with regard to the following description and accompanying drawings where:

FIG. 1 is a side perspective view of a first illustrative embodiment of a digital tape measure system in accordance with the present disclosure, with an angle finder in a stowed position.

FIG. 2 shows the system of FIG. 1 with an angle-finder depicted at various angles.

FIG. 3 shows the system of FIG. 1 and illustrates calculating an inside length or an outside length.

FIG. 4 shows the system of FIG. 1 in use to obtain an outside measurement.

FIG. 5 shows the system of FIG. 1 in use to obtain an inside measurement.

FIG. 6 depicts inside and outside angles on walls that may be present where work is performed to illustrate an outside angle and an inside angle.

FIG. 7 shows the system of FIG. 1 in use to record length and an outside angle at the same time.

FIG. 8 shows the system of FIG. 1 in use to record length and an inside angle at the same time.

FIG. 9 shows an image of a portion of blades used in traditional tape measures.

FIG. 10 is a closeup image of a portion of a blade for a tape measure system in accordance with the present disclosure, with 1/16-inch markings that have 1/16-inch gaps between them on the outside edge and a second band of 1/32-inch markings with 1/32-inch gaps running down the middle of the blade.

FIG. 11 is an example of a tick-mark shape for use on a blade for a tape measure system in accordance with the present disclosure, which is precise enough for both a human user and an optical sensor to read the correct tick-mark representation.

FIG. 12 depicts a blade for a tape measure system in accordance with the present disclosure, which has information readable by a digital reader printed in the same area as different information which is visually readable by a person.

FIG. 13 depicts a tape measure in accordance with the present disclosure, which includes a bumper button on the front of the tape measure body. When pushed, could be a command to “record distance from the hook to the front of the tape body” or “when user pushes the ‘record’ button, records distance from the hook to the front of the tape body.”

FIG. 14 depicts a tape measure in accordance with the present disclosure, which includes a bumper button on the back of the tape measure. When pushed, could be a “record distance from the hook to the back of the tape body” or “when user pushes the ‘record’ button, records distance from the hook to the back of the tape body.”

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION

The disclosure extends to methods, systems, and devices for taking precise digital measurements. In the following description of the disclosure, reference is made to the accompanying drawings, which form a part hereof, and in which is shown by way of illustration specific implementations in which the disclosure may be practiced. It is understood that other implementations may be utilized, and structural changes may be made without departing from the scope of the disclosure.

Before the methods, systems and devices of the present disclosure are discussed and described, it is to be understood that this disclosure is not limited to the particular configurations, process steps, and materials disclosed herein as such configurations, process steps, and materials may vary somewhat. It is also to be understood that the terminology employed herein is used for the purpose of describing implementations only and is not intended to be limiting since the scope of the disclosure will be limited only by the appended claims and equivalents thereof.

In describing and claiming the disclosure, the following terminology will be used in accordance with the definitions set out below.

It must be noted that, as used in this specification and the appended claims, the singular forms “a,” “an,” and “the” include plural referents unless the context clearly dictates otherwise.

As used herein, the terms “comprising,” “including,” “containing,” “characterized by,” and grammatical equivalents thereof are inclusive or open-ended terms that do not exclude additional, unrecited elements or method steps.

Further, although specific implementations of the disclosure have been described and illustrated, the disclosure is not to be limited to the specific forms or arrangements of parts so described and illustrated. The scope of the disclosure is to be defined by the claims appended hereto, any future claims submitted here and in different applications, and their equivalents.

Apparatus and systems in accordance with the present disclosure may be useful as part of a precision cutting system, such as those disclosed in pending patent application serial no. U.S. Ser. No. 18/048,055 filed Oct. 21, 2022 and entitled PRECISION CUTTING GUIDE SYSTEM, the disclosure of which is incorporated here by reference in its entirety.

In some illustrative embodiments, systems in accordance with the present disclosure utilized units of measurement that are displayed by the digital tape measure in a form that can easily be recorded by hand by simple visual reading of the numbers, while simultaneously allowing measurements from the system to be displayed or recorded by the onboard computer and recalled later, and/or to be sent wirelessly or via a wired cable to an external device, such as a cell phone or a computer with a computer-aided design (CAD) program.

When preparing to install custom length material, a tape measure is a necessary tool; first, one is needed to determine how long the material needs to be for the project, then again to measure the required length on the material and note where to cut. There are digital tape measures on the market that can aid in reading a tape measure. These typically cost between $30 and $300, depending on accuracy, quality, and features. This disclosure relates to systems that may include a digital tape measure which is also capable of measuring an angle. Some such systems may incorporate a digital angle-finder or a digital protractor (for the purposes of this disclosure, the terms “angle finder” and “protractor” may be used interchangeably). The need to capture a combination of length and angle measurements is often required in construction and manufacturing. Currently, a first tool is used to measure the needed length, and a separate, second tool is used to record the angle needed. Then these sperate measurements are recorded, either digitally or, more commonly, written by hand. These measurements are then transferred to a tool that can be used to cut the material. Recording the measurements is a common source of error.

Systems in accordance with the present disclosure may have the capability to record a length and an end angle needed to be cut, and to transmit these measurements to a recording device that can display the needed measurements or save them digitally. This will save the user time, increase accuracy and precision, and minimize errors in recording. In one illustrative embodiment, such a system may include a tape measuring unit with a tape measure portion and a digital angle finder portion, such an illustrative system may be referred to as a “tape measure unit”.

Users will be able to zero the angle finder to determine the change in angle required when cutting the material. For example, when cutting with a miter saw, 0° denotes a cut that is perpendicular to the fence, but when using a table saw, 0° denotes a cut that is parallel to the saw fence. By allowing users to set the zero angle, they can decide which measurement is most meaningful for their use case.

If a user is cutting baseboards, flooring, crown molding, etc., the system may measure the angle between two walls (like in a corner), as well as the length of material needed. If the user always uses a tape measure unit to take measurement from the same side—for instance, always the left side of the material to be cut, the angle finding functions may be used to determine whether the corner is an inside corner or an outside corner and then accurately transmit the required cuts to the recording device. For example, if a user comes up to an 88° inside corner, the system could inform the user that they need a 44° angle cut to the left side of the end of the material and a 44° angle cut to the right side at the beginning of the next piece of material. Allowing the system to perform the angle math will save the end user time and minimize mistakes in coming up with a cut-list.

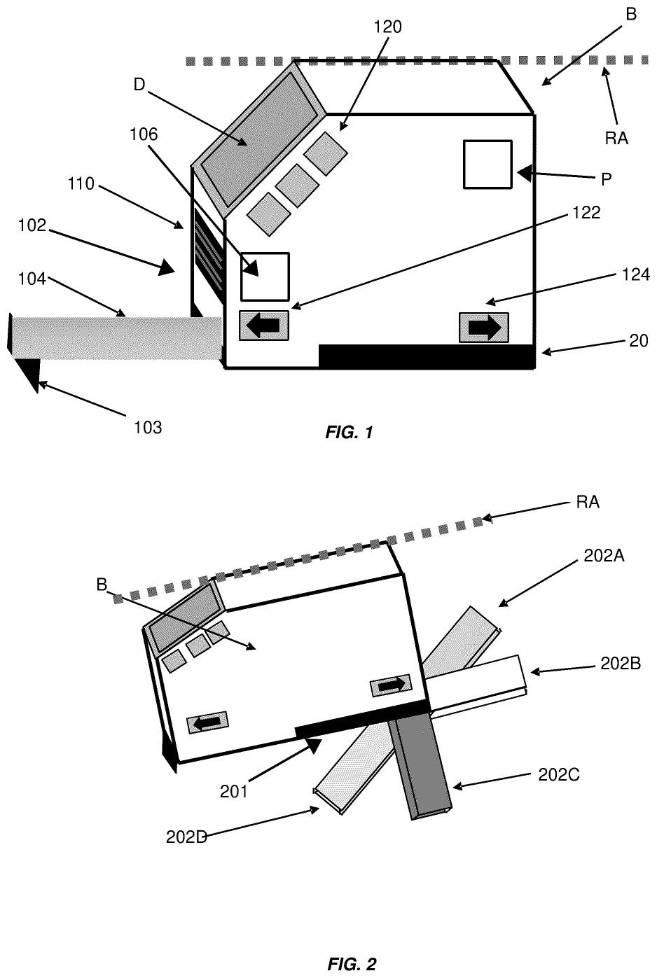

FIGS. 1 through 8 depict some embodiments of illustrative systems in accordance with the present disclosure, in isolation and in use. As best depicted in FIGS. 1 through 5, a body B houses a digital measuring system 10, that includes a measuring blade 104 and an optical scanner (represented at 106). A digital angle finder system 20 includes an angle measuring member 202 attached to the body, movable from a stored to deployed conformations. A processing unit P is disposed in the body in communication with the digital measuring system 10 and digital angle finder system 20 to record measured angles and lengths, and capture length and angle data to perform calculations. In some embodiments, the system may communicate with a separate cutting system using, an appropriate wireless communications protocol, for automatic adjustment of the cutting system to generate desired cuts on workpieces.

As depicted in FIGS. 1 through 5, some components that may be included with the illustrative system depicted therein include a hook member 103, disposed at the distal end of the measuring blade 104. It will be appreciated that measuring blade 104 retracts to a spooled position inside the housing allowing the optical scanner 106 to read is as it is extended or retracted. A tape position lock switch 110 may be disposed on the body along with a display screen D. Menu buttons 120 may be present to allow for interaction with displayed menus. A front edge recording button 122 and a rear edge button 124 may be present as well.

As best shown in FIG. 2, when angle measuring member 202 is pivotally moved out of the storage recess 201 in body B, it may be disposed at different angles for measurement. Where reference angle line RA represents a parallel line against the upper side of body B, such as a wall, the various depicted positions depicted at 202A, 202B, 202C, and 202D respectively depict the angle measuring member measuring angles of 225 degrees, 180 degrees, 90 degrees and 45 degrees, all from reference angle line RA.

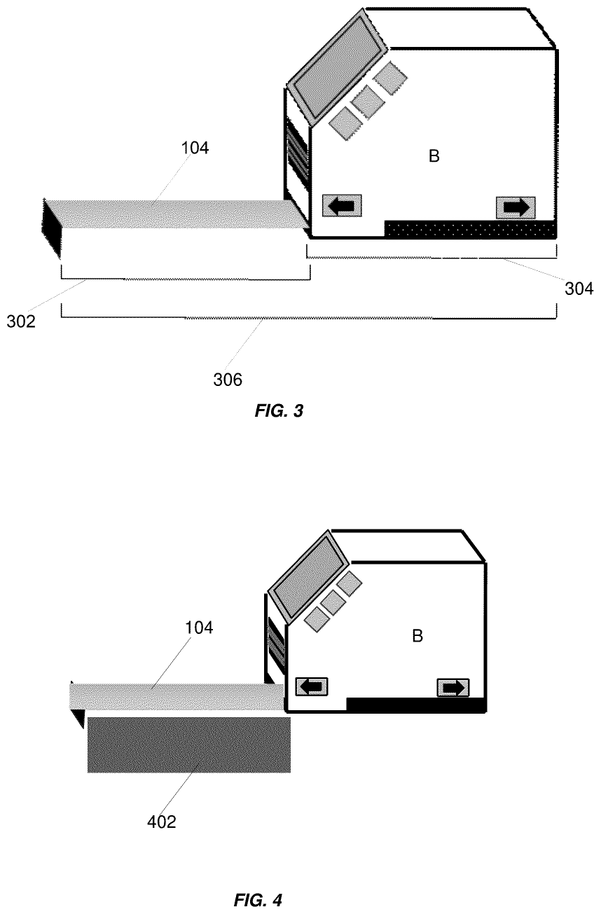

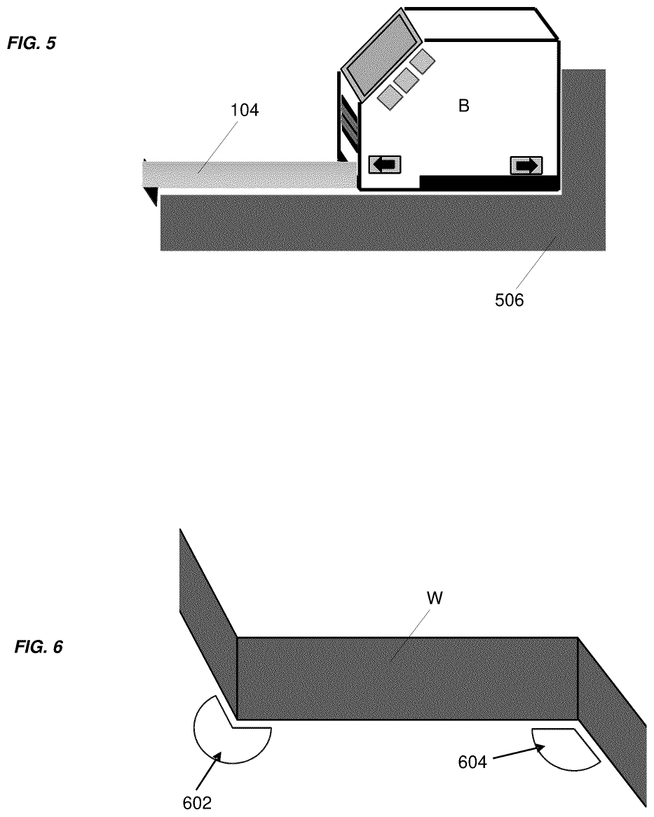

FIG. 3 illustrates the system with tape 104 extended to measure a total tape length or outside length indicated at 302, the length of the body B indicated at 304 and a total distance used for measuring an inside length 306 using as the sum of outside length 302 and body length 304. Similarly, FIG. 4 shows the system in use to obtain an outside measurement 402 and FIG. 5 shows the system in use to obtain an inside measurement 506 with body B placed in a corner.

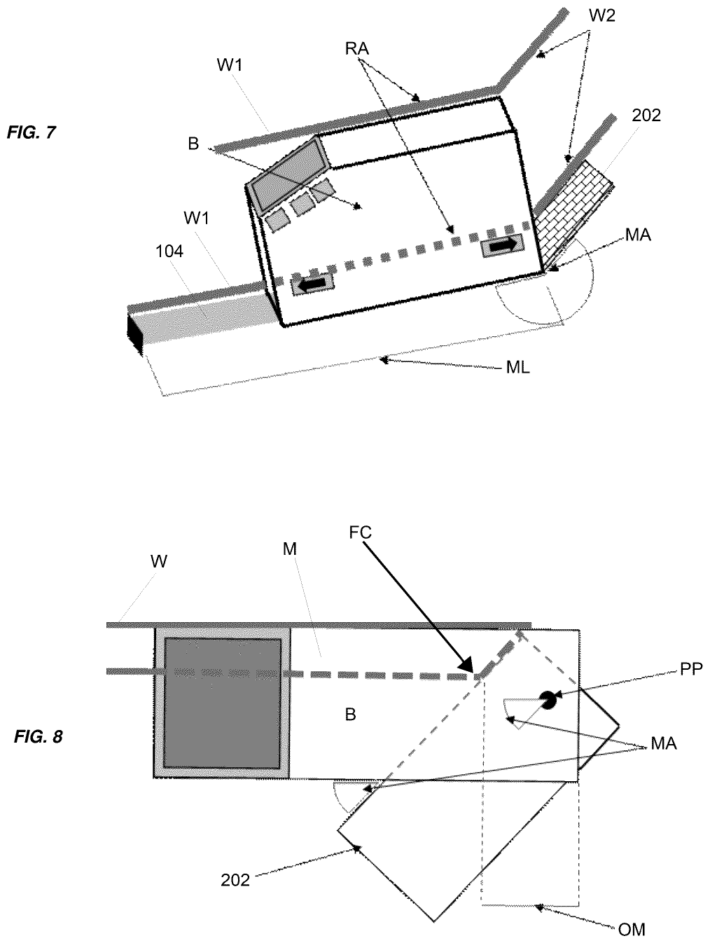

FIG. 6 depicts inside and outside angles on walls that may be present where work is performed to illustrate an outside angle 602 and an inside angle 604. For measurements where inside and/or outside angles on walls W are required, if measuring with the blade 104 to the left, and 0° of the angle finder represents that the item is parallel with the wall, the angle shown may be displayed on the angle finder for an inside and an outside measurement. i.e., <180° for an inside corner and >180° for an outside measurement. FIG. 7 shows such a system with tape 104 extended, such that tape length and body length define a total measured length body B parallel to a first wall reference angle RA, and angle measuring member 202 is used to measure an outside measured angle MA at a rear side of body B.

It will be appreciated that the system may include appropriate hardware and software for performing these calculations. The calculations for the angle could be performed by the processor P located in the tape measure unit or by a processor on the receiving hardware, such as a cell phone, a computer operating a CAD program, or a precision cutting system which is in communication with the tape measure unit.

As discussed, systems in accordance with the present disclosure include a digital angle-finder portion. This allows a user to simultaneously measure both the angle and the length that need to be cut, using the digital angle finder portion and the digital tape measure portion of the system. These readings may be recorded digitally into an onboard computer of the system, sent wirelessly or via wire to an external recorder, or be read from a digital display D on the tape measure body.

The angle finder portion may be physically attached to the tape measure body as denoted in the drawings, but it will be appreciated that in some embodiments, it may be removable and reattachable to allow it to be separated from the tape measure body for separate use with the data collected thereby captured by the systems via wireless technology, such as Bluetooth.

Systems in accordance with the present disclosure may include an integrated accelerometer to allow the system to be used to measure an angle that is perpendicular to the physical angle-finder. For example, if the tape measure body is placed against a wall, it could act as a digital level and tell the user if the wall is vertical or at an angle; then the digital angle-finder could be used to measure the angle between two walls. This double-angle feature would be particularly helpful for installing crown molding or baseboards when the walls are not perfectly vertical.

Systems in accordance with the present disclosure include an angle finder accessible on that tape measure body to allow a user to record the length of a board as well as what the end angle should be. This will save time and minimize potential mistakes. Because the reference point can be determined before measuring boards, the user can always know what direction the angle of the saw blade should be, compared to the reference angle. For example, 0° can mean a cut that is parallel with the length measurement, or 0° can mean a cut that is perpendicular to the length measurement. This is important when using a table saw (parallel) or a miter saw (perpendicular). FIGS. 1 through 8 depict some embodiments of systems in accordance with the present disclosure, in isolation and in use.

In some exemplary uses, these systems may allow a user who is measuring baseboards, flooring, crown molding, etc., to know if they came up to an inside angle, an outside angle, or a door frame. This could be accomplished by always using the same side of the angle finder; i.e., the user could pull the tape to the length being measured with the tape to the left side and the tape body against the reference wall, then rotate the angle finder from the stored position to an angle between 1° and 179° for an inside angle, between 181° and 359° for an outside angle, and keep it stored at 0° to denote a door frame or other end point. A reading of 180° could also be used to denote a special cut that is on the end of a board that is different from an inside angle cut and an outside angle cut, or 0°. The alternate recorded angle could be used to note to the user to use a coping cut or other decorative cut method instead of the expected cut.

An additional feature could include the situation in which a user is cutting baseboards on a miter saw and measures an inside corner of 80°, where the recording software knows to have a 40° left angle (−40°) to cut the end of the board, then has the user set the saw to 40° right (+40°) for the start of the next board.

### Digital Angle-Finder Offset

The digital angle-finder could be used to measure baseboards or other materials to be cut and installed. One feature of the combination length and angle combination is to allow the user to employ the angle finder as the physical end point of the measurement.

For example, as illustrated in FIG. 8, if measuring with the blade out to the left of the tape and measuring an outside 90° corner, the front of the tape measure could be used as the total length recorded. Or the angle finder could be rotated to 270° counterclockwise from the stored position and the user could put the angle finder against the wall and the angle finder would denote the end point of the length measurement.

When doing a non-90° angle, the math requires incorporating trigonometry to ensure that the total length of the tape measure is recorded correctly. As depicted in FIG. 8, these systems may record points and angles and perform these calculations. In FIG. 8, the measured angle MA calculated from the position of the angle measuring member 202 with respect to its pivot point PP, allows for the calculation of an offset measurement OM to the front point needed for a bevel cut on a molding M to be placed on wall W. The digital display could denote the assumed location of the end point for the measurement location. All required trigonometry functions would be calculated onboard the tape measure computer.

### Tape Technology

Systems in accordance with the present disclosure may further include markings that can be read by both a human user and by an optical encoder. This can allow the systems to incorporate linear encoding technology.

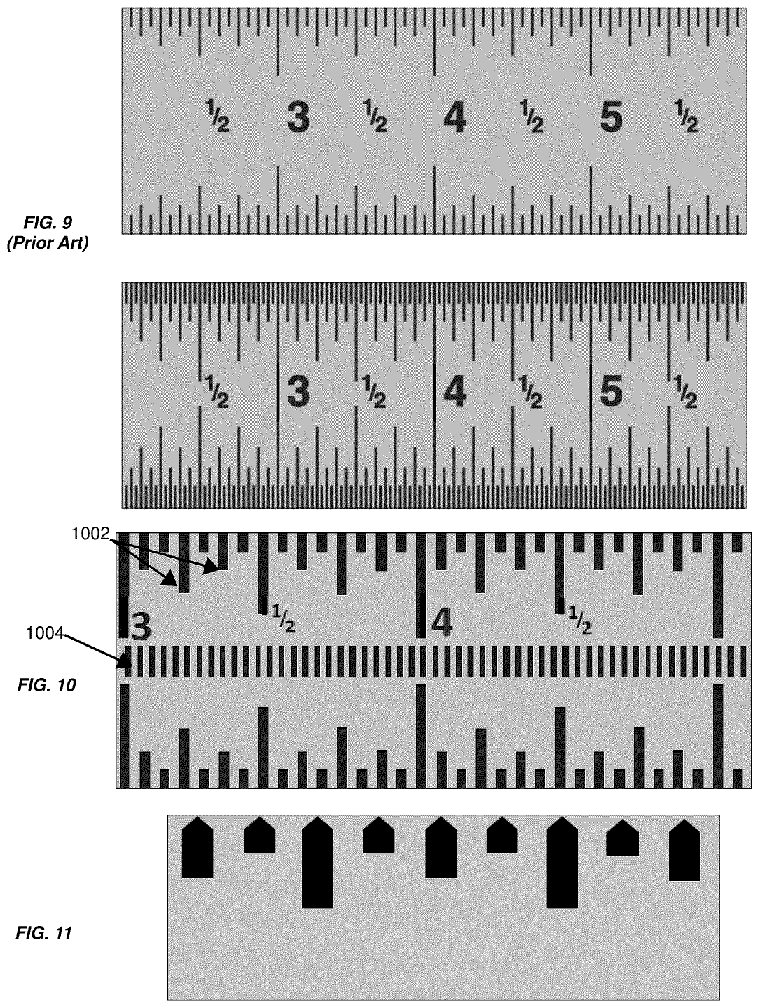

FIG. 9 shows an image of a traditional tape measure (prior art), a tape measure with 1/32-inch markings with 1/32-inch gaps along the outside edges, and a tape measure with 1/64-inch-wide markings with 1/64-inch gaps down the middle. FIGS. 10-11 depict tape measure blades that may be useful in systems in accordance with the present disclosure.

Digital tape measure linear encoding technology useful in systems in accordance with the present disclosure require that the blade of the tape have a specific pattern printed on it that can be read by an optical sensor that is measuring the reflectivity of the tick marks. The width of the tick marks being read by the optical sensor must be the same as the width of the spacing between them. For example, if using imperial units, the 1/32-inch marks that are along the edge of the blade will need to be 1/32-inch wide with 1/32-inch spacing between them. These could be 1/16 inch, 1/64 inch, or cm or mm units instead. An optical reader that can count how many tick marks have gone by will be able to track how many have passed the reader by using a second optical reader that has a slight offset. The onboard computer will be able to use quadrature to determine whether the tape is being pulled in or out, and how far in each direction it has moved.

If the tick marks are being used as the optical reading pattern as well as the pattern read by a person, the tick marks are required to be a minimum width and a maximum width in order to allow the optical reader to read the lines. If these lines are too wide to be used for a reliable resolution for a person to read, the tick marks may come to a point to delineate the correct point for a person to read as depicted in FIG. 11. To increase accuracy, it is possible that another strip that will run somewhere else (that is, not the top edge typically used by a person to read the tape measure) along the length of the blade and may include more precise tick marks. For example, if the edge tick marks are 1/32 inch apart, then 1/64-inch-wide tick marks could be used that are also 1/64 inch apart. This secondary banding could be used as a more precise linear encoding method that could be used as a comparison for determining whether a discrepancy has occurred, and a line or a space was missed in the count. The units need not be 1/32 or 1/64 inch to work. They could be metric or any other unit, as long as the width of each tick mark is the same as the width of the space between the tick marks and is different from the tick marks that are delineating the measurements being read by human. Interpolation can be used to amplify the resolution, and by having an offset in the sensors, quadrature can be used to determine whether the tape is being pulled out or pushed into the body.

If there is a discrepancy between the large and small scale, a message may appear on the display asking the user to return the tape measure back to zero to reset the device.

A Hall-effect sensor, a physical limit switch, an optical sensor, or other sensing technology could be used to determine if the tape has been fully retracted and can send a signal to the onboard computer that the current length it should be reading is zero.

FIG. 10 depicts a closeup image of a tape measure with 1/16-inch markings 1002 that have 1/16-inch gaps between them on the outside edge and a second band of 1/32-inch markings 1004 with 1/32-inch gaps running down the middle of the blade.

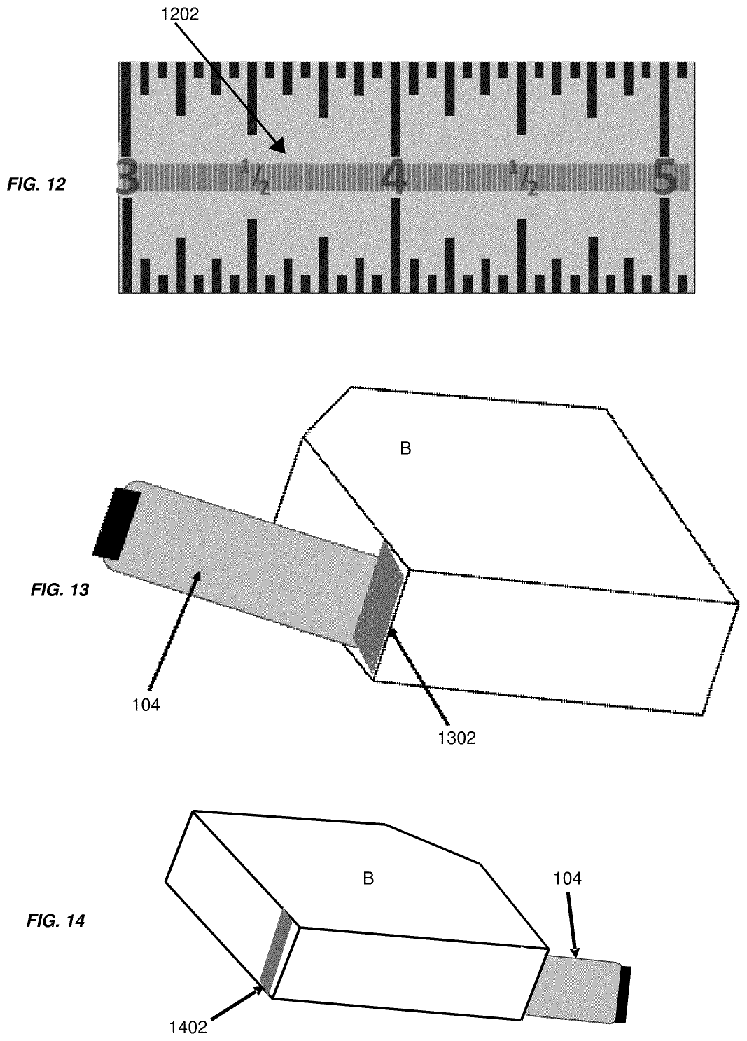

Turning to FIG. 12, a blade for a system of “Invisible” or “hidden” tick marks is depicted. In such embodiments, the glossy part of a tape measure can have a matte printing of tick marks 1202 that are readable by a digital reader but the information printed in the same area can still be read by a person. Typically, digital tape measures require a light-and-dark pattern to be printed so that the electronic sensor sees a dark area and a light area and can tell the difference between them. This is usually accomplished by printing a black tick mark with a white space (or other light color) between the tick marks.

In systems in accordance with the present disclosure, a digital encoded strip invisible to the end user may be formed by the use of different inks/paints on the tape. For example, instead of printing a black (or dark) tick mark on the tape, printing the tick marks in the same color as the background but with different reflectivity (i.e., printing in alternating gloss and matte ink/paint of the same color instead of alternating black and white ink/paint) allows the electronic sensor to be able to read the difference in reflectivity while presenting a commonly colored tape portion to the user's vision. The system's optical sensor may “see” the matte paint as dark and the gloss paint as light. This can allow more information to be incorporated into the tape; for example, printing a logo in the middle of the encoded strip, or a larger visible number indicating which inch mark or fraction of an inch is being denoted for a user to read, would not impede the sensor reading the encoded strip, even if the visual strip and the encoded strip are in the same place on the tape.

In some embodiments, the tick marks may be formed as pores in an upper clear reflective layer. For example, a clear upper reflective layer may be removed at selected locations by etching to produce tick marks of the same visible color. Such etching could be performed by any suitable means, including laser ablation, chemical treatment, mechanical removal or as otherwise known in the art.

Alternatively, the tick marks could also be printed in an ultraviolet (UV) or infra-red (IR) ink that is invisible to a person but visible to a sensor calibrated to read that ink. This would make it easier to have a printed ink that is large enough for people to read and a separate printed ink that is easy for a sensor to read. In such embodiments, the system may include a suitable light source, such as a UV or IR laser. The light source and sensor may be controlled by a processor as part of the linear encoder.

### Offset Tape Feature:

The user may have the option to zero the tape measure to a location that they would like to call the reference level. Frequently a user will line up a non-digital tape measure with a one-inch or a one-foot mark, for example, and call that zero, then subtract that distance from the final distance measured. This minimizes any error in the wiggle in the hook at the end of the blade when a hook gets bent or is not being trusted for some other reason. It can also be used when a tape measure has been pulled to a length to be recorded, then pulled past to a second length but the total length is not desired; the distance between distance 1 and distance 2 is the required length. When done on an analogue tape measure, this increases the likelihood of user error if the user forgets to subtract the offset when recording the measurement or making a math mistake. A digital tool would include a display with a reminder to the user that there is an offset being recorded as well as a discrepancy between the length that a person would read and the length being displayed on the tape measure body screen.

### “Find My Tape”

Tape measures are easily misplaced, and an onboard audible and/or visual signal may be incorporated and triggered by an external device such as a cell phone or other wirelessly connected device to allow a user to quickly find the tool.

### Bumper Sensors/Switches

When pulling a tape measure to the length to be recorded, a non-digital tape measure will be pulled beyond what is needed so that a user can determine the correct distance and then line up one of the tick marks with the correct length and then read the tape (and either write down the number or remember it). With a digital tape measure, the distance from which the hook has been pulled away from the tape measure body is the distance that it is reading. A “settings” button, or a physical button pushed by a user, can be used to tell the tape measure to record the distance that the blade is away from the tape body; i.e., the total distance from the end of the blade to the mouth of the tape measure body, or the last tick mark that a user would be able to see. There is an option to include the length of the tape measure body so that a user can measure the inside distance (FIG. 5).

A switch built into a bumper on the front and/or back end could be used to tell the tape measure which end to record from. When measuring the length of an outside corner, the user would pull the tape beyond the needed length, then let the tape retract to the correct position; then the user would push the tape body into the edge to depress the bumper switch, which could record the length, or a user could still be required to push a “record” button. A front bumper button 1302 is depicted in FIG. 13.

A second or rear switch 1402 could be placed on the opposite side of the tape measure body, as depicted in FIG. 14, allowing a user to push the tape measure body into an inside corner to depress the switch that could denote that that is a measurement to record. Or the bumper button being depressed could denote that the when the user pushes the “record” button, the user is intending to measure an inside corner, and the tape measure should record the length of tape visible as well as the length of the tape body.

### Display

The display for most current digital tape measures is placed with an orientation that is easy to read while holding the tape body for a right-handed user. In systems in accordance with the present disclosure, the tape measure body may include an accelerometer that can be used to determine which way is “up” for the display and allow the onboard computer to rotate the display so left- and right-handed operation can be easily used, as well as making the tape easier to read vertically, similar to a rotated screen on a smart phone or tablet.

It is to be understood that the above-described arrangements are only illustrative of the application of the principles of the disclosure. Numerous modifications and alternative arrangements may be devised by those skilled in the art without departing from the spirit and scope of the disclosure and the appended claims are intended to cover such modifications and arrangements. Thus, while the disclosure has been shown in the drawings and described above with particularity and detail, it will be apparent to those of ordinary skill in the art that numerous modifications, including, but not limited to, variations in size, materials, shape, form, function and manner of operation, assembly and use may be made without departing from the principles and concepts set forth herein.

What is claimed is:

1. A digital measuring system comprising:
a body;
a digital tape measure housed within the body, comprising a measuring blade and an optical scanner;
a digital angle finder attached to the body; and
at least one processor, wherein the system may be actuated to record measured angles and lengths, and the processor may capture length and angle data to perform calculations for a separate cutting system.

2. The system of claim 1, wherein the digital angel finder includes an angle measuring member that is deployable from a stowed position in the body to a measuring position with a distal end outside the body.

3. The system of claim 2, further comprising a linear encoder which uses the optical scanner to read tick marks on the measuring blade to determine an extended length of the measuring blade from the body to calculate a distance being measured by the system.

4. The system of claim 3, wherein the system shines a light on the measuring blade and measures how reflective the surface is at the optical scanner to read the tick marks.

5. The system of claim 4, wherein the tick marks are printed on the blade in the same color as the background with a different reflectivity.

6. The system of claim 3, wherein the processor calculates a distance being measured by the system which includes at least a portion of the deployed angle measuring member and an extended length of the measuring blade.

7. The system of claim 6, wherein the angle finder member is used as a physical endpoint of measurement and the processor utilizes an angle measured by the digital angle finder to calculate an offset measurement for performing a bevel cut on a workpiece.

8. The system of claim 6, wherein the angle finder member is pivotally attached to the body of the system.

9. The system of claim 1, further comprising a button disposed on a rear surface of the body, which is actuatable by pressing the body against a surface that contact the button, such that when actuated, the processor calculates a distance including a length of the body.

10. A digital measuring system comprising:
a system body;
a digital tape measure housed within the body, comprising a measuring blade and a linear encoder which reads tick marks on the measuring blade to determine an extended length of the measuring blade from the system body to calculate a distance being measured by the system;
a digital angle finder attached to the body; and
at least one processor, wherein the system may be actuated to record measured angles and lengths, and the processor may capture length and angle data to perform calculations for a cutting a workpiece.

11. The system of claim 10, further wherein the linear encoder which uses an optical scanner to read tick marks on the measuring blade to determine an extended length of the measuring blade from the system body.

12. The system of claim 11, wherein the system shines a light on the measuring blade and measures how reflective the surface is at the optical scanner to read the tick marks.

13. The system of claim 12, wherein the tick marks are printed on the blade in the same color as the background with a different reflectivity.

14. The system of claim 12, wherein the tick marks are formed as pores in a translucent upper layer disposed on the blade.

15. The system of claim 10, wherein the digital angle finder includes an angle measuring member that is deployable from a stowed position in the system body to a measuring position with a distal end outside the system body.

16. The system of claim 15, wherein the angle finder member is pivotally attached to the system body in a storage recess.

17. The system of claim 15, wherein the processor calculates a distance being measured by the system which includes at least a portion of the deployed angle measuring member and an extended length of the measuring blade.

18. The system of claim 17, wherein the angle finder member is used as a physical endpoint of measurement and the processor utilizes an angle measured by the digital angle finder to calculate an offset measurement for performing a bevel cut on a workpiece.

19. The system of claim 10, further comprising a button disposed on a rear surface of the body, which is actuatable by pressing the body against a surface that contacts the button, such that when actuated, the processor calculates a distance including a length of the body.

20. The system of claim 10, wherein the body further comprises a digital display and a set of input buttons for selecting menu options.
